(19) United States
(12) Patent Application Publication
(10) Pub. No.: US 2009/0107132 A1
(43) Pub. Date: Apr. 30, 2009

(54) HYDRAULIC SUPPLY SYSTEM WITH AN ADJUSTABLE PUMP

(76) Inventor: Hans Esders, Hildesheim (DE)

Correspondence Address: ZARLEY LAW FIRM P.L.C., CAPITAL SQUARE, 400 LOCUST, SUITE 200, DES MOINES, IA, 50309-2350, US

(21) Appl. No.: 12/260,129

(22) Filed: Oct. 29, 2008

(30) Foreign Application Priority Data
Oct. 29, 2007 (DE) 10 2007 051 525.3

(51) Int. Cl. F15B 13/06

(52) U.S. Cl. 60/420; 60/445

(57) ABSTRACT

The invention relates to a hydraulic supply system with an adjustable pump for supplying at least one safety-critical consumer to be supplied as a matter of priority and at least one non-safety-critical consumer. The adjustable pump control is configured for adapting the flow generated by the pump to the instantaneous requirements of the consumers and has a flow control valve for controlling the pump. The adjustable pump control further comprises switching, hydraulically actuated valves which cause the priority supply of the at least one safety-critical consumer and are activated by a hydraulic release signal generated in the region of the at least one safety-critical consumer.

### BACKGROUND OF THE INVENTION

The invention relates to a hydraulic supply system with an adjustable pump for supplying at least one safety-critical consumer which is to be supplied as a matter of priority and at least one non-critical consumer according to the features of claim 1.

The most widespread circuit for hydraulic systems with an adjustable pump is the load sensing system. Load sensing systems ensure the adaptation of pressure and volume flow to the instantaneous requirements of the consumers, the highest load pressure occurring in the system being returned to the load sensing control of the pump and compared to the pump pressure in order to set the delivered hydraulic power accordingly. Systems of this type are usually embodied in a hydraulic manner. They can however also be configured electronically over the entire control system or in parts thereof; this requires corresponding software and on the consumer side a corresponding electronic load pressure sensing and/or on sides of the pump an electronic pump control.

In an electronically controlled hydraulic system, very high safety requirements have to be fulfilled, if this system extends to functions such as steering, the trailer brake and the like, in which a failure can have severe consequences. On the other hand, the hydraulic supply must however also operate subsystems, such as the working hydraulics or what are known as the comfort hydraulics, in which it is not necessary to adhere to comparable safety standards such as are conventionally stipulated in SILs (safety integrity levels), i.e. as a requirement placed on the likelihood of a safety function failing. If appropriate, in the aforementioned cases, either separate systems have to be set up in differing SIL levels, or all partial systems, i.e. even those which are per se non-critical, have to be equipped with a correspondingly high SIL.

The aim of the invention is to ensure improved hydraulic supply of consumers having differing SIL requirements.

### SUMMARY OF THE INVENTION

According to the invention, this is achieved through a hydraulic supply system with an adjustable pump for supplying at least one safety critical consumer to be supplied with priority, and at least one non-safety-critical consumer, the adjustable pump is configured for adapting the flow generated by a pump to the instantaneous requirements of the consumers and has a flow control valve for regulating the pump and also switching, hydraulically actuated valves which cause the priority supply of the at least one safety-critical consumer and are activated by a hydraulic release signal generated in the region of the at least one safety-critical consumer (SKS). In the contro for adjusting the pump, this allows either the use of electronics to be eliminated altogether or, if electronics are used in this region, they do not have to meet the high safety requirements such as are required for example for the steering or the braking system.

Preferably, the hydraulic supply system has a switching release valve which is associated with the safety-critical consumers and generates the hydraulic release signal which can be supplied to the switching, hydraulically actuated valves located in the pump control via a release line. The supply of non-safety-critical consumers is thus released by a hydraulic signal to the adjustable pump control generated in the safety-critical consumer or consumers. The electrical and electronic signal processing remains in this case limited to the safety-critical components which have to satisfy relatively high safety requirements anyway.

Advantageously, in normal operation, the release valve connects the release signal line for acting on the switching valves to the supply line of the safety-critical consumers, whereas it discharges this release signal line to the tank in the event of a malfunction.

In further embodiments of the invention, the switching, hydraulically actuated valves of the adjustable pump control comprise a stroking valve and a priority valve. The stroking valve exerts, in accordance with a hydraulic release signal, in a first position no effect on a servo system causing the adjustment of the pump and in a second position activates the servo system independently of the flow control valve in such a way that the adjustable pump strokes to maximum displacement. The priority valve isolates, in accordance with the hydraulic release signal, in one of its two positions the non-safety-critical consumers from the supply and feeds the flow only to the safety-critical consumers. This ensures that in the event of a disturbance the full pump capacity is available to the safety-critical consumers.

Advantageously, the adjustable pump control comprises, in addition to the flow control valve, a pressure regulating valve which overrides the flow control valve on reaching a predetermined pressure and as a result limits the pressure to a maximum value.

The invention can also be applied to a plurality of safety-critical consumers with each a release valve and a release line associated. A hydraulic circuit, with which the lowest release signal pressure is selected, is provided for this purpose. In the hydraulic circuit for selecting the lowest release signal pressure, two respective release lines acting on a switching valve by the pressures to be compared, are compared to each other, and the lower release signal pressure is forwarded. The line having the lower release signal pressure can then be compared to a further release line. In this way, the arrangement can be continued and the lowest release signal pressure selected.

Further features and advantages of the invention will emerge from the following description of the figures in which:

### BRIEF DESCRIPTION OF THE DRAWINGS

FIG. 1 shows an exemplary embodiment of the invention with an electronic pump control;

FIG. 2 shows an exemplary embodiment of the invention with a hydraulic pump control; and

FIG. 3 shows a circuit for determining the release signal in a plurality of safety-critical consumers.

### DETAILED DESCRIPTION OF THE PREFERRED EMBODIMENT

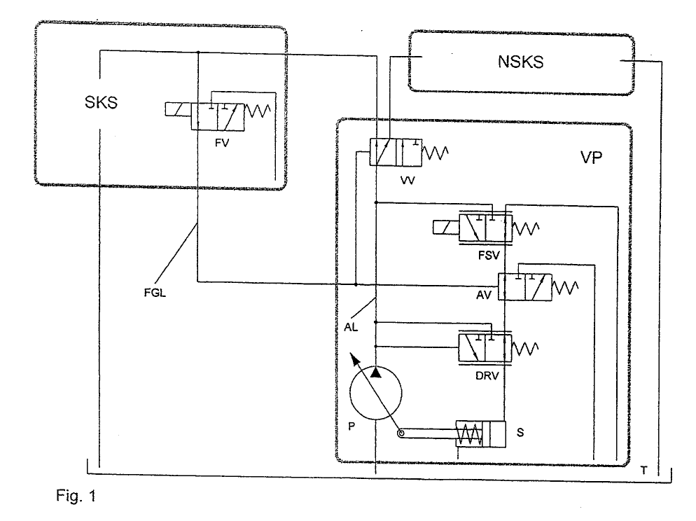

FIG. 1 shows a first exemplary embodiment of the invention. An adjustable pump VP supplies a flow via the working line AL and supplies various consumers which are not shown in detail and are combined in the two blocks NSKS and SKS, wherein NSKS denotes the non-safety-critical hydraulic or electrohydraulic subsystems, which therefore like the adjustable pump VP do not need to be SIL-compliant, and SKS the safety-critical electrohydraulic subsystems.

The pump P is controlled by means of a servo system S. When the cylinder of the servo system is discharged toward the tank T, the pump P strokes to maximum displacement. Conversely, the pump P strokes in the minimum displacement direction, when hydraulic pressure is supplied to the cylinder of the servo system S.

The control for the adjustable pump VP has a flow control valve FSV and a pressure regulating valve DRV. The flow control valve FSV is activated in the example shown electrically in accordance with the electronic controller. Via the flow control valve FSV, the servo system S is supplied with corresponding hydraulic pressure and controls in this way the displacement of the pump P such that precisely the flow required by the consumers is provided. When the load pressure is very high, the flow control valve reaches the position indicated in FIG. 1. In order to limit the maximum pressure in the working line, the flow control valve FSV is then finally overridden by the pressure regulating valve DRV. The pressure regulating valve sets the displacement in such a way, that the maximum pressure is maintained but not exceeded.

Basically, the pressure regulating valve DRV is not critical for the principle according to the invention. If it is used as in the illustrated exemplary embodiment, it should during the electronic pump regulation be closer to the pump control cylinder of the servo system S than the flow control valve FSV in order to eliminate unexpected reactions in the event of any malfunctions. The situation is in this regard somewhat different to that during the hydraulic pump control, in which the order of the flow valve and pressure regulating valve is immaterial. Since in the example shown the flow control valve is activated electronically, these electronics could in principle, in conjunction with suitable sensors, also take over the function of the pressure regulating valve. It is however advantageous to keep the pressure regulating valve mechanically redundant in the illustrated manner. Otherwise, in the event of a malfunction, the pump could be caused to stroke despite the high pressure; this would then for example stall the engine of a propel drive.

The system illustrated in FIG. 1 causes hydraulically prioritized supply of the safety-critical consumers in the event of a malfunction of the electronic open and closed-loop control system. This preferred supply is ensured in the adjustable pump contro by a stroking valve AV and a priority valve VV which are each activated hydraulically by a release signal. This release signal is generated by an electrically activatable release valve FV in the safety-critical partial system FV, compared to which the adjustable pump control satisfies much lower safety requirements.

The stroking valve AV is arranged as a switching valve between the flow control valve FSV and the pressure limiting valve DRV and has in the position shown, under the release signal pressure applied via the release line FGL, no effect on the control of the pump. If the release signal drops below a predetermined value, the stroking valve assumes its second position owing to a spring and ensures that the servo cylinder S is discharged to the tank T and the pump strokes up to maximum, the stroking valve AV also being overridden if appropriate by the pressure regulating valve DRV. The flow control valve then has no longer an influence on the adjustment of the pump. The stroking valve AV thus allows a maximum flow or a maximum pressure in the working line AL to be brought about independently of the requirements of electronics which may be operating defectively.

The priority valve VV is likewise a pure switching valve having minimum throttling losses. With hydraulic pressure by the release signal, the priority valve assumes the position shown in FIG. 1, in which it provides the flow supplied by the pump both to the non-safety-critical and to the safety-critical consumers. On loss of the release signal, or if the force exerted by it drops below that of a the feedback spring, the priority valve switches to its second position and as a result provides flow of the pump in its entirety only to the safety-critical partial system SKS.

The hydraulic release signal for the two valves AV and VV is generated in the safety-critical partial system with the electrically actuated release valve FV. In the safety-critical partial system SKS, SIL-compliant electronic data processing takes place anyway, so that merely the release valve has still to be added. Sufficient pressure from the supply line leading to the safety-critical consumers is provided to the two valves AV, VV via the release line FGL. In this case, no permanent flow flows via the release line, so that almost no power loss is produced as a result.

During electrical activation of the release valve FV by an electrical signal displaying a malfunction, the release valve assumes its second position in which it isolates the release line from the pressure line and instead discharges to the tank, as a result of which the loads on the left-hand side, as shown in FIG. 1, of the stroking valve AV and of the priority valve VV are reduced, so that these valves switch to their position indicated in each case on the right-hand side. The springs of the stroking valve and priority valve AV, VV are in this case selected in such a way that they switch even at a relatively low pressure, for example at 5 bar. This would then be the stand-by pressure which the pump must maintain at all times during regular operation.

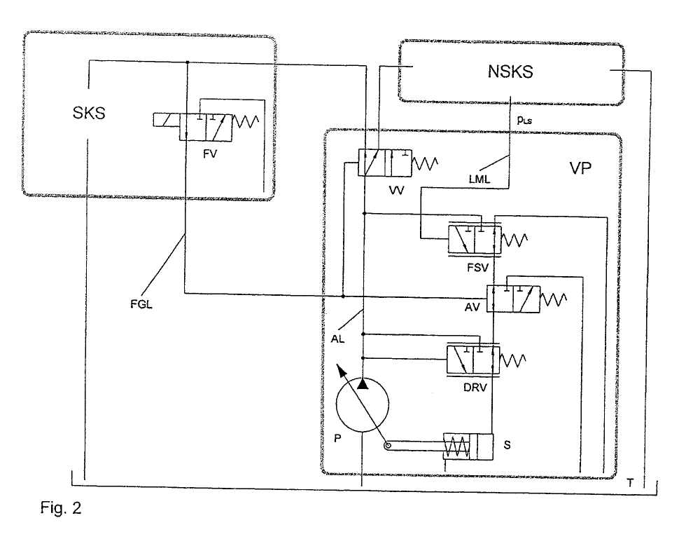

The principle described hereinbefore of hydraulically prioritized supply of safety-critical consumers can be implemented also with a hydraulically controlled pump. This is illustrated in FIG. 2 based on the example of a conventional load sensing control. For like components and modules, the reference symbols from FIG. 1 are in this case maintained. The flow control valve is according to FIG. 2 no longer adjusted with the force of a proportional magnet but rather with the highest load pressure PLS which is reported back by the connected load sensing system via the load pressure reporting line LML. The flow of the pump is then regulated in such a way that an equilibrium results from the spring force on the spool side of the flow control valve on the one hand and the force from the pressure in the load pressure reporting line on the other hand. As a result, the pressure differential above the feed control port of the consumer having the highest load is kept constant. The highest load pressure is determined from the load pressures of all active consumers in a known manner with a cascade of shuttle valves. Otherwise, the control of the pump is identical in terms of design and also in the mode of operation to that in FIG. 1, to the description of which reference is made.

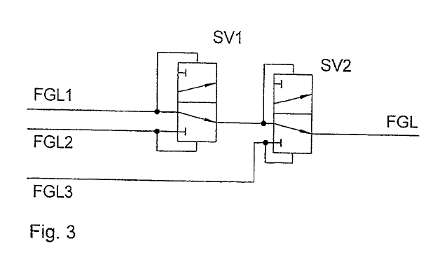

The proposed principle may also be extended to a plurality of safety-critical consumers. For this purpose, for the effective release line FGL, the lowest of all release signal pressures is selected from a plurality of release signal lines FGL1, FGL2, FGL3, as is illustrated in FIG. 3. Associated with two lines FGL1, FGL2 is a switching valve SV1 which is acted on hydraulically from both sides, in each case by one of the pressures to be compared, in such a way that said switching valve forwards the lower of the two. A further release signal line FGL3 can then be compared in the switching valve SV2 to the remaining line. In principle, this procedure can be continued indefinitely. The lowest release signal pressure then remaining serves to act on the stroking valve and the priority valve AV, VV.

In the described manner it is possible to achieve, in electronically regulated hydraulic systems too, a supply which preferentially supplies safety-critical consumers, such as the steering or trailer brake, in the event of the failure of electronic components and thus satisfies a high safety standard.

1. Hydraulic supply system for a plurality of consumers with an electronic load sensing control for adapting the flow generated by an adjustable pump to the instantaneous requirements of the consumers, wherein the load sensing control has a flow control valve for regulating the adjustable pump, which flow control valve can be activated in accordance with the consumer having the highest load, and wherein the supply system has a priority means which ensures priority supply of safety-critical consumers by switching valves.

2. Hydraulic supply system according to claim 1, wherein a pressure regulating valve is provided which overrides the flow control valve on reaching a predetermined displacement and as a result limits the flow to a maximum pressure value.

3. Hydraulic supply system according to claim 1, wherein the priority means has a stroking valve which, in accordance with a hydraulic release signal, in a first position exerts no effect on the control of the pump and in a second position activates the servo system independently of the flow control valve in such a way that the adjustable pump strokes to maximum misplacement.

4. Hydraulic supply system according to claim 1, wherein the priority means has a priority valve which, in accordance with a hydraulic release signal, in one of its two positions isolates non-safety-critical consumers from the supply and feeds the flow only to safety-critical consumers.

5. Hydraulic supply system according to claim 1, wherein the priority means has an electrically activatable release valve which generates a hydraulic release signal for acting on the switching valves.

6. Hydraulic supply system according to claim 5, wherein the release valve connects in normal operation for acting on the switching valves a release signal line to the supply line of safety-critical consumers and in the event of a malfunction discharges the release line to the tank.

7. Hydraulic supply system according to claim 1, wherein a plurality of safety-critical consumers are provided, with each of which a release valve and a release line are associated, with a hydraulic circuit for selecting the lowest release signal pressure, two release lines being compared in a switching valve acted on by the pressures to be compared and the lower release signal pressure being forwarded.

8. Hydraulic supply system according to claim 7, wherein the remaining line having the lower release signal pressure is compared to a further release line.
